(19) United States
(12) Patent Application Publication
(10) Pub. No.: US 2026/0348195 A1
(43) Pub. Date: Nov. 5, 2026

(54) LOCKING DEVICE AND LOCK

(71) Applicant: Xueshi SHEN, Suzhou City (CN)

(72) Inventor: Xueshi SHEN, Suzhou City (CN)

(73) Assignee: Suzhou Woma Vehicle Co., Ltd., Suzhou City (CN)

(21) Appl. No.: 19/197,980

(22) Filed: May 3, 2025

(51) Int. Cl. E05B 63/00; E05B 15/04

(52) U.S. Cl. CPC E05B 63/0013; E05B 15/04

(57) ABSTRACT

A locking device and a lock are provided. The locking device configured to be inserted between a first lock housing and a second lock housing to restrict relative movement therebetween. The locking device includes a lock body and a locking assembly. The lock body is provided with a limiting hole, a locking block, and a first locking protrusion. The locking block is disposed within the limiting hole, and the first locking protrusion is configured to restrict relative rotation between the first lock housing and the second lock housing. The locking assembly is provided with a locking groove and a second locking protrusion, a portion of the locking assembly is disposed within the limiting hole, and the locking assembly is configured to move between a locked position and an unlocked position.

### TECHNICAL FIELD

The present invention relates to the technical field of locks, and in particular, to a locking device and a lock.

### BACKGROUND OF THE INVENTION

Locks, as essential devices for securing items, are widely used in various fields throughout society, such as doors and windows, luggage, and mechanical equipment. The locking device, as the core component of a lock, has a structural design that directly determines the lock's performance and application.

Currently, existing locking devices on the market primarily include pin-tumbler locking devices, wafer-tumbler locking devices, and sidebar locking devices. A pin-tumbler locking device typically comprises a housing, a core, pins, springs, and a keyway. During operation, insertion of the key pushes the lower pins upward via the key cuts, aligning the interface between the upper and lower pins with the shear line between the housing and the core, thereby allowing the core to rotate and unlock the device. A wafer-tumbler locking device generally includes wafers (reeds), locking device slots, springs, and a key, and the wafers act as locking elements. When the key is inserted, the key cuts displace the wafers horizontally until their notches align with the shear line, permitting the core to rotate. A sidebar locking device includes sidebar lugs, wafers, springs, and an inner-milled groove key. Upon key insertion, the wafers form specific notches due to the varying heights of the key cuts, enabling the sidebar lugs to engage the notches and release the locking device for rotation. These locking devices have relatively complex structures and are mainly suitable for scenarios with high-security requirements, such as doors, windows, and valuable items. However, for items like toys and wardrobes, which are usually placed in relatively safe external environments (such as at home or carried around), the cost of using the above-mentioned locking devices is relatively high. Since these items only need to prevent the locked objects from moving relative to each other to maintain a fixed locked state, the demand for security is relatively low, while the demand for the convenience and simplicity of the locking device is higher.

Therefore, the present invention provides a locking device and a lock, which can effectively solve the above problems. The locking device and the lock have a simple structure and are convenient to use.

### SUMMARY OF THE INVENTION

In order to overcome the shortcomings of the prior art, the present invention provides a locking device and a lock, which have a simple structure and are convenient to use.

The technical solution adopted by the present invention to solve the technical problem is as follows.

A locking device configured to be inserted between a first lock housing and a second lock housing to restrict relative movement therebetween. The locking device includes a lock body and a locking assembly.

The lock body is provided with a limiting hole, a locking block, and a first locking protrusion. The locking block is disposed within the limiting hole, and the first locking protrusion is configured to restrict relative rotation between the first lock housing and the second lock housing.

The locking assembly is provided with a locking groove and a second locking protrusion, a portion of the locking assembly is disposed within the limiting hole, and the locking assembly is configured to move between a locked position and an
unlocked position; when the locking assembly is in the locked position, the locking block is inserted into the locking groove, and the second locking protrusion is engaged with the first lock housing to prevent extraction of the locking device from the first lock housing and the second lock housing.

As an improvement of the present invention, an edge at an end of the locking assembly facing away from the second locking protrusion is inwardly recessed to form the locking groove.

As an improvement of the present invention, the locking assembly includes a locking member and a connecting member connected to the locking member, and the second locking protrusion is disposed at an end of the connecting member facing away from the locking member.

As an improvement of the present invention, the locking device further includes an elastic member; the locking member is provided with a receiving space, and the elastic member is disposed within the receiving space; one end of the elastic member is connected to the connecting member, and the other end is connected to the locking member; the elastic member biases the locking member from the unlocked position toward the locked position.

As an improvement of the present invention, the elastic member is configured to match the receiving space in both size and shape.

As an improvement of the present invention, the locking member is movable along a longitudinal axis of the limiting hole between the locked position and the unlocked position.

As an improvement of the present invention, the connecting member and the locking member are rotatable about the longitudinal axis of the limiting hole between a first position and a second position.

As an improvement of the present invention, the connecting member is provided with a limiting groove configured to enable rotation of the connecting member between the first position and the second position; the lock body is provided with a limiting member inserted into the limiting groove to retain at least a portion of the connecting member within the limiting hole.

As an improvement of the present invention, the limiting groove is a sector-shaped groove, and a central angle of the sector-shaped groove ranges from 30° to 90°.

As an improvement of the present invention, the lock body is provided with an insertion hole in communication with the limiting groove, and the limiting member is removably arranged within the insertion hole; when the limiting member is disposed within the insertion hole and an end of the limiting member is inserted into the limiting groove, at least a portion of the connecting member is disposed within the limiting hole.

As an improvement of the present invention, an end of the connecting member facing away from the second locking protrusion defines a connecting end; the locking member is provided with a recessed structure, the recessed structure is configured to match the connecting end in both shape and size, and the connecting end is inserted into the recessed structure.

As an improvement of the present invention, the recessed structure has a non-circular configuration.

As an improvement of the present invention, both the lock body and the locking assembly are made of non-metallic materials.

A lock includes a locking device, a first lock housing, and a second lock housing.

The locking device includes a lock body and a locking assembly. The lock body is provided with a limiting hole, a locking block, and a first locking protrusion, the locking block is disposed within the limiting hole, and the first locking protrusion is configured to restrict relative rotation between the first lock housing and the second lock housing.

The locking assembly is provided with a locking groove and a second locking protrusion, a portion of the locking assembly is disposed within the limiting hole, and the locking assembly is configured to move between a locked position and an unlocked position; when the locking assembly is in the locked position, the locking block is inserted into the locking groove, and the second locking protrusion is engaged with the first lock housing to prevent extraction of the locking device from the first lock housing and the second lock housing; when the locking assembly is in the unlocked position, the locking groove is disengaged from the locking block, the second locking protrusion is detached from the first lock housing, and the second locking protrusion is configured to correspond to the first locking protrusion to enable the extraction of the locking device from the first lock housing and the second lock housing.

As an improvement of the present invention, the locking assembly includes a locking member and a connecting member connected to the locking member, and the second locking protrusion is disposed at an end of the connecting member facing away from the locking member; the locking device further includes an elastic member; the locking member is provided with a receiving space, and the elastic member is disposed within the receiving space; one end of the elastic member is connected to the connecting member, and the other end is connected to the locking member; the elastic member biases the locking member from the unlocked position toward the locked position.

As an improvement of the present invention, the locking member is movable along a longitudinal axis of the limiting hole between the locked position and the unlocked position; the connecting member and the locking member are rotatable about a longitudinal axis of the limiting hole between a first position and a second position.

As an improvement of the present invention, the connecting member is provided with a limiting groove configured to enable rotation of the connecting member between the first position and the second position; the lock body is provided with a limiting member inserted into the limiting groove, and at least a portion of the connecting member is disposed within the limiting hole.

As an improvement of the present invention, the limiting groove is a sector-shaped groove, and a central angle of the sector-shaped groove ranges from 30° to 90°.

As an improvement of the present invention, an end of the connecting member facing away from the second locking protrusion defines a connecting end; the locking member is provided with a recessed structure, the recessed structure is configured to match the connecting end in both shape and size, and the connecting end is inserted into the recessed structure.

As an improvement of the present invention, the recessed structure has a non-circular configuration.

Beneficial effects: by the arrangement of the above structure, the present invention provides a locking device and a lock, which have a simple structure and are convenient to use.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic diagram of an overall structure of a locking device from an angle according to the present invention;

FIG. 2 is a schematic diagram of an overall structure of the locking device from another angle according to the present invention;

FIG. 3 is a schematic diagram of an exploded structure of the locking device from an angle according to the present invention;

FIG. 4 is a schematic diagram of an exploded structure of the locking device from another angle according to the present invention;

FIG. 5 is a rear view of a lock body of the locking device according to the present invention;

FIG. 6 is a rear view of the locking device disposed in a locked position according to the present invention;

FIG. 7 is a cross-sectional diagram shown in FIG. 6 along line A-A;

FIG. 8 is a rear view of the locking device disposed in an unlocked position according to the present invention;

FIG. 9 is a cross-sectional diagram shown in FIG. 8 along line B-B;

FIG. 10 is a rear view of the locking device disposed in a ready-to-lock position according to the present invention;

FIG. 11 is a cross-sectional diagram shown in FIG. 10 along line C-C;

FIG. 12 is a side view of a connecting member disposed in a first position according to the present invention;

FIG. 13 is a cross-sectional diagram shown in FIG. 12 along line D-D;

FIG. 14 is a side view of the connecting member disposed in a second position according to the present invention;

FIG. 15 is a cross-sectional diagram shown in FIG. 14 along line E-E;

FIG. 16 is a schematic diagram of an exploded structure of a lock from an angle according to the present invention;

FIG. 17 is a schematic diagram of an exploded structure of the lock from another angle according to the present invention; and

FIG. 18 is a cross-sectional diagram of the lock according to the present invention.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

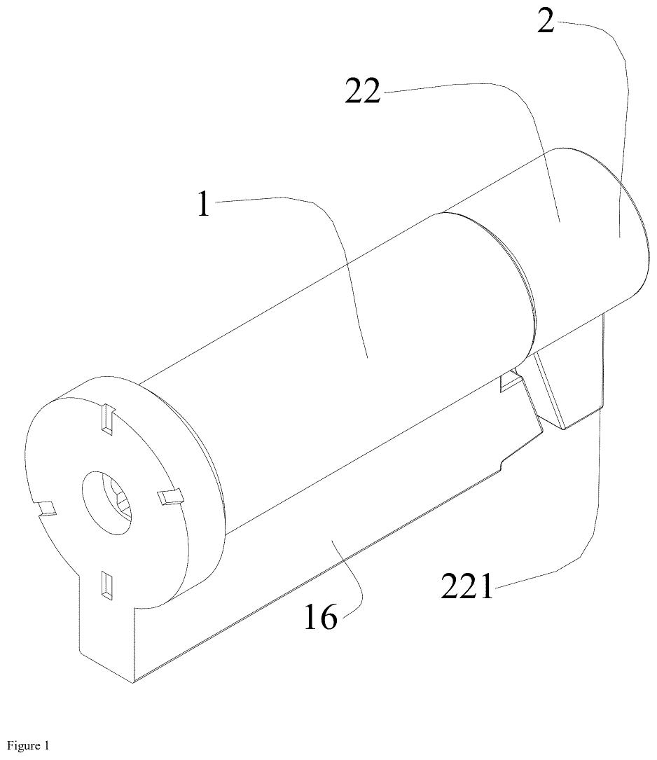

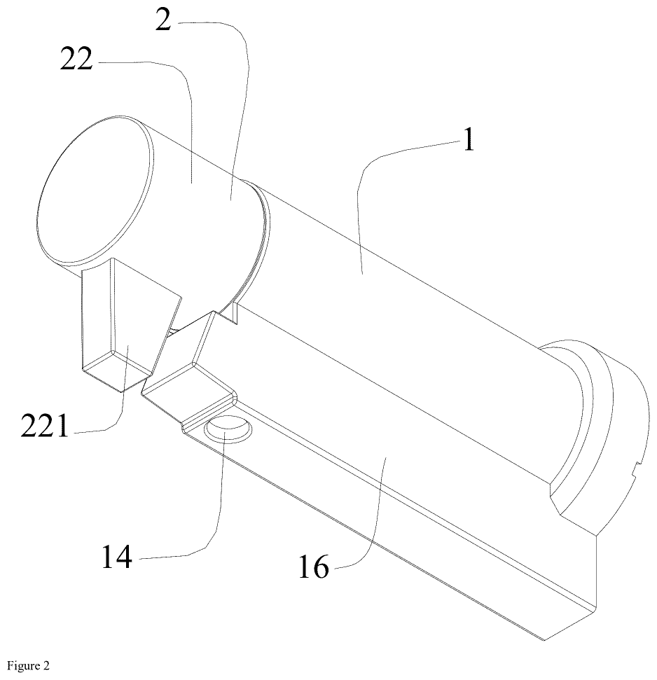

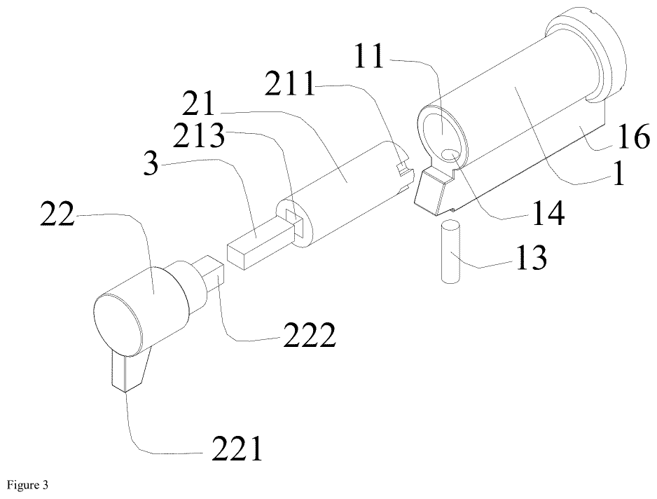

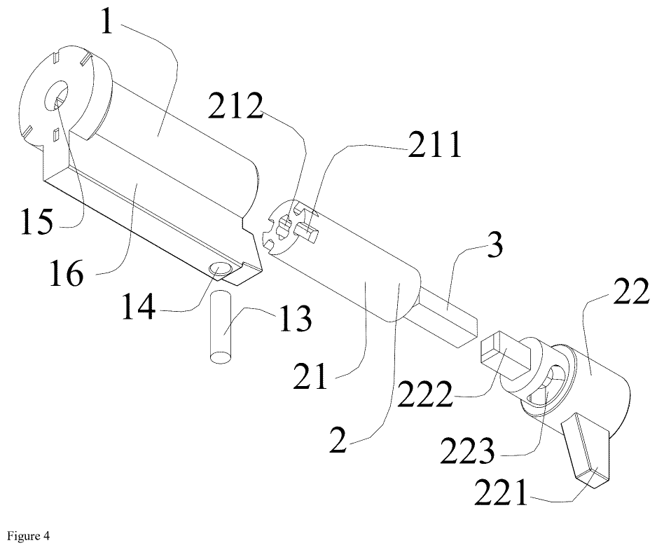

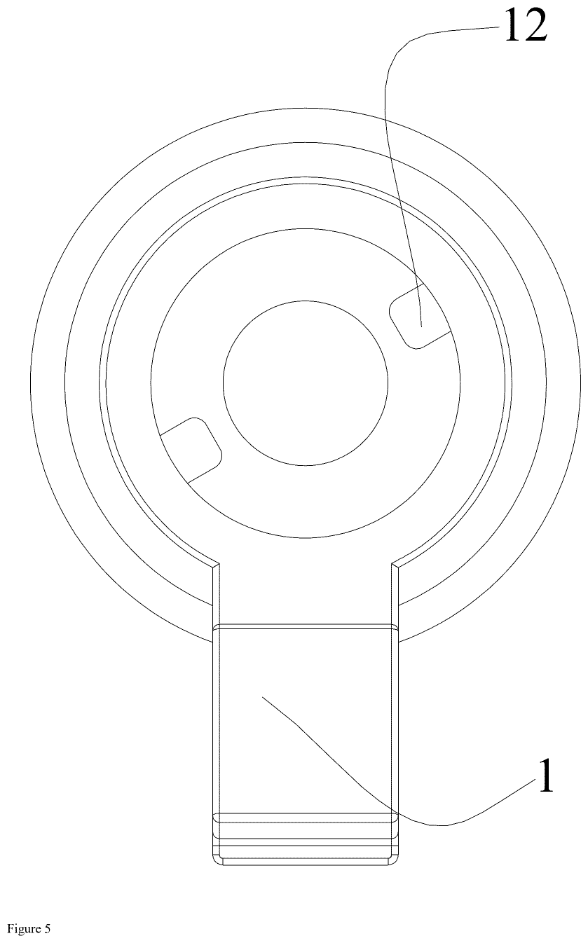

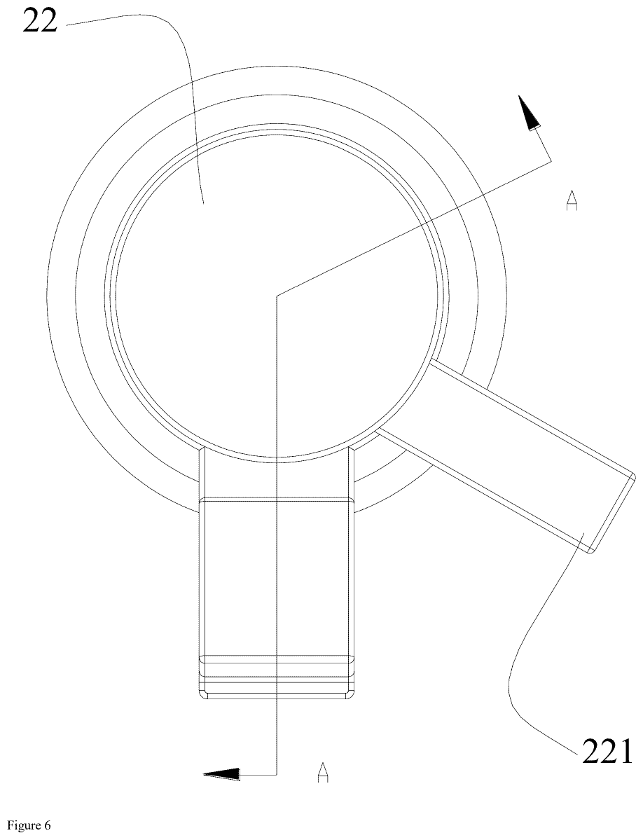

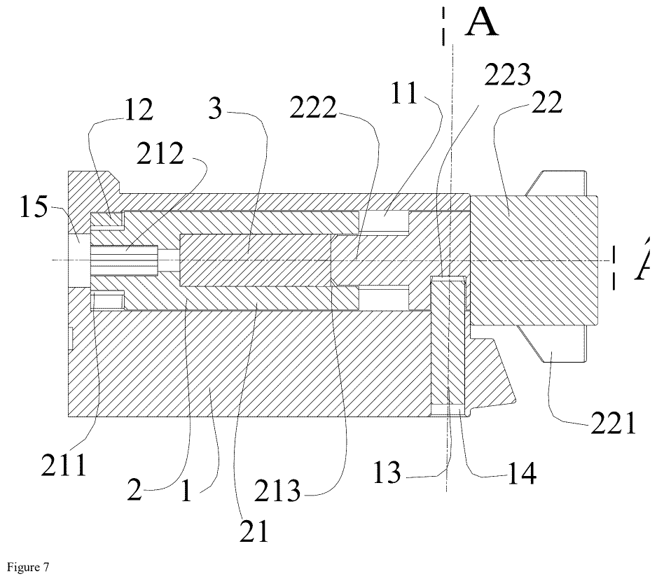

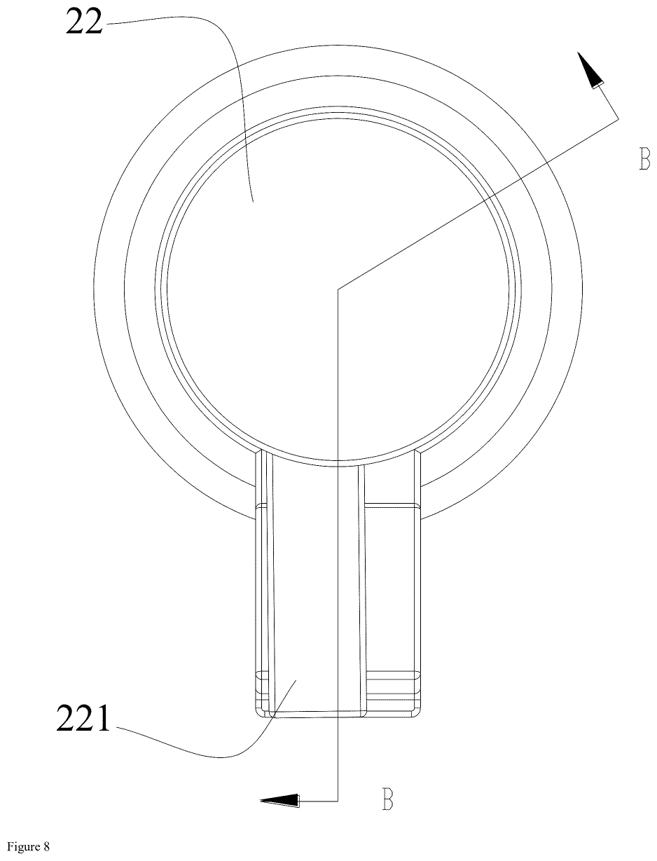

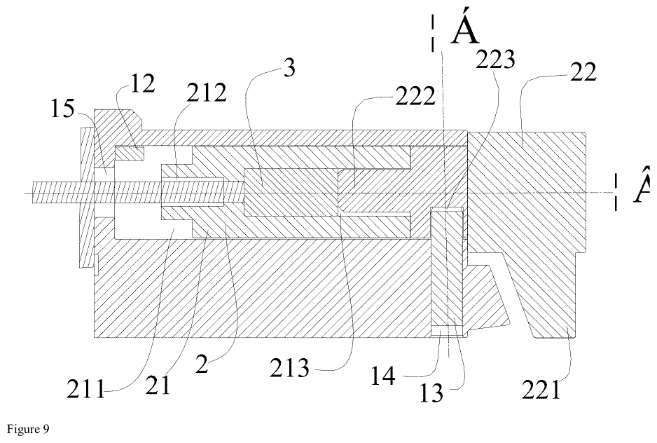

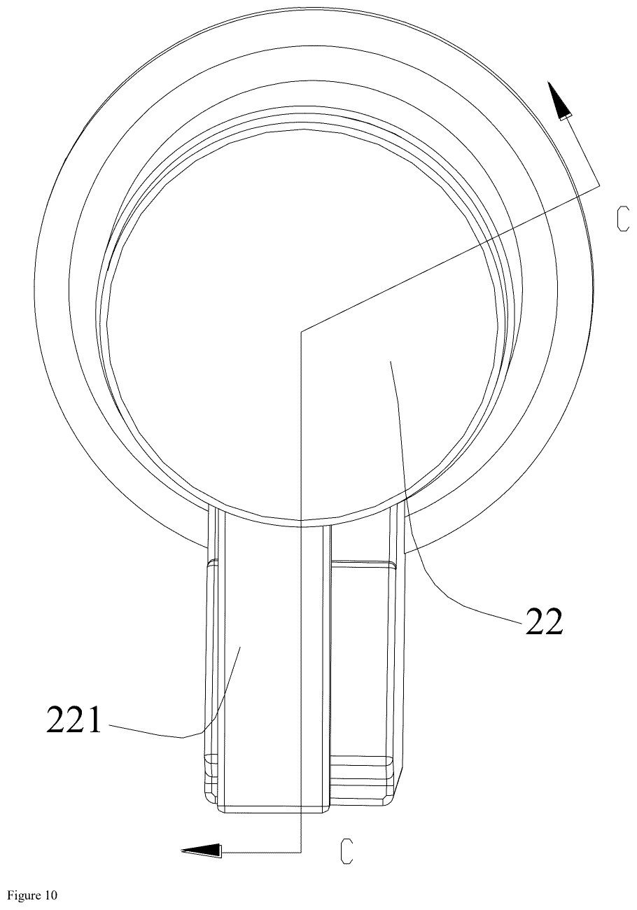

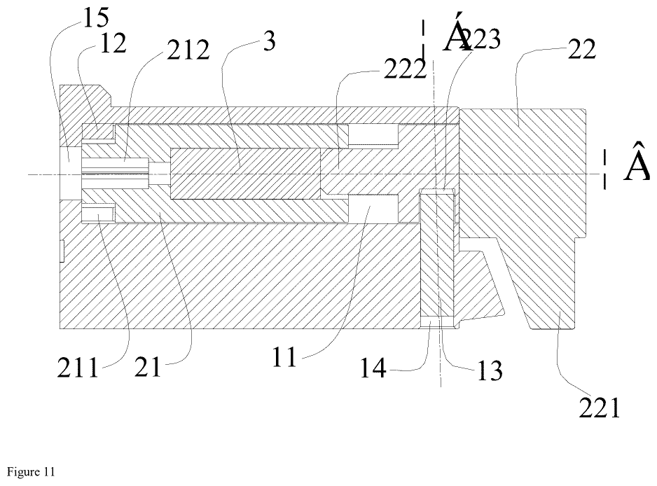

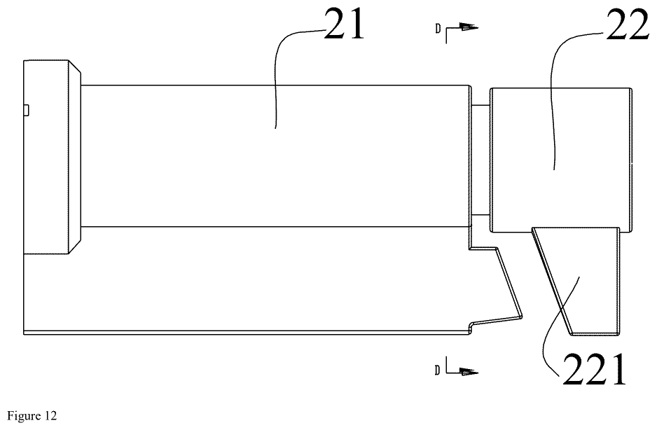

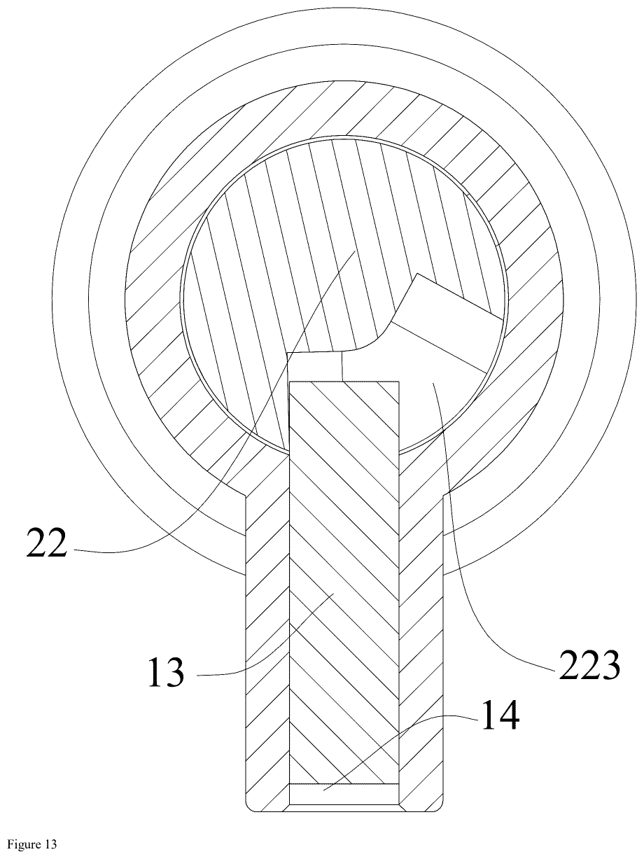

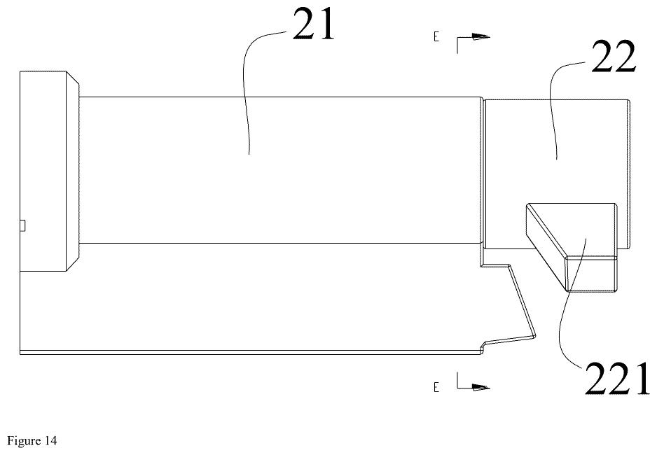

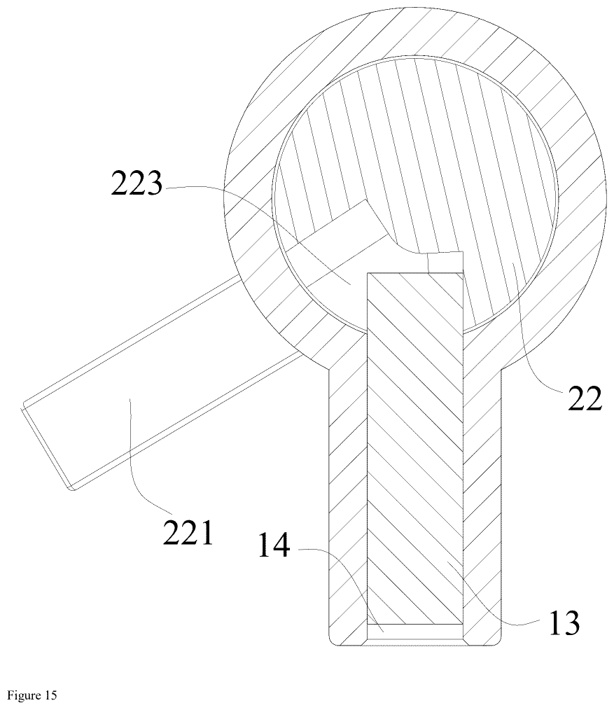

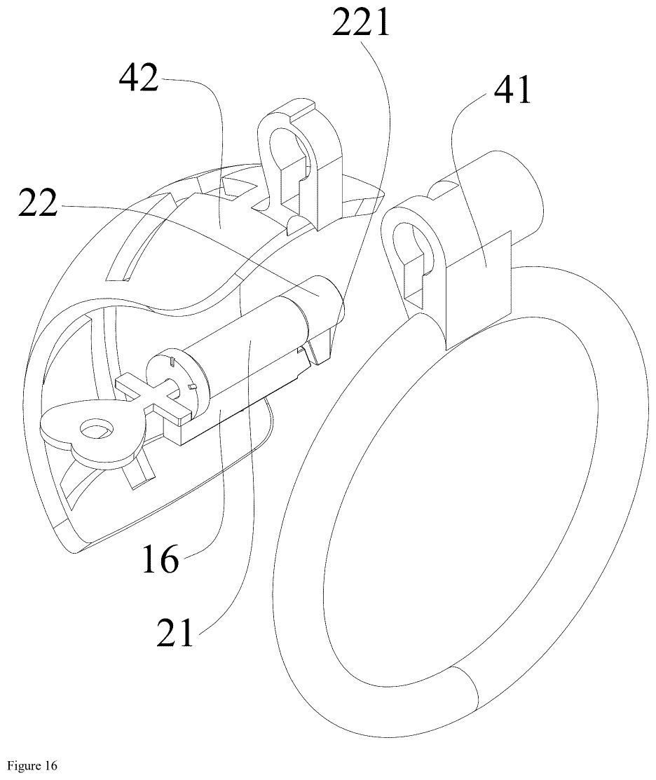

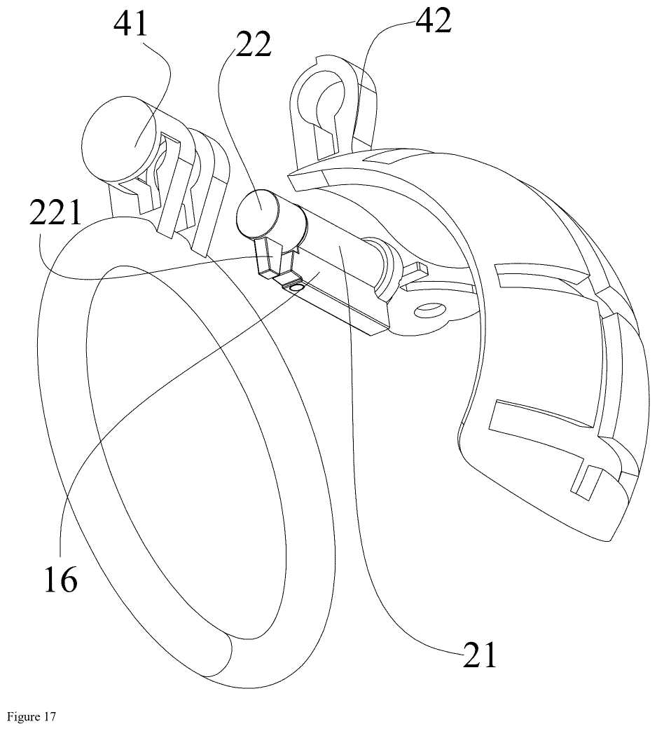

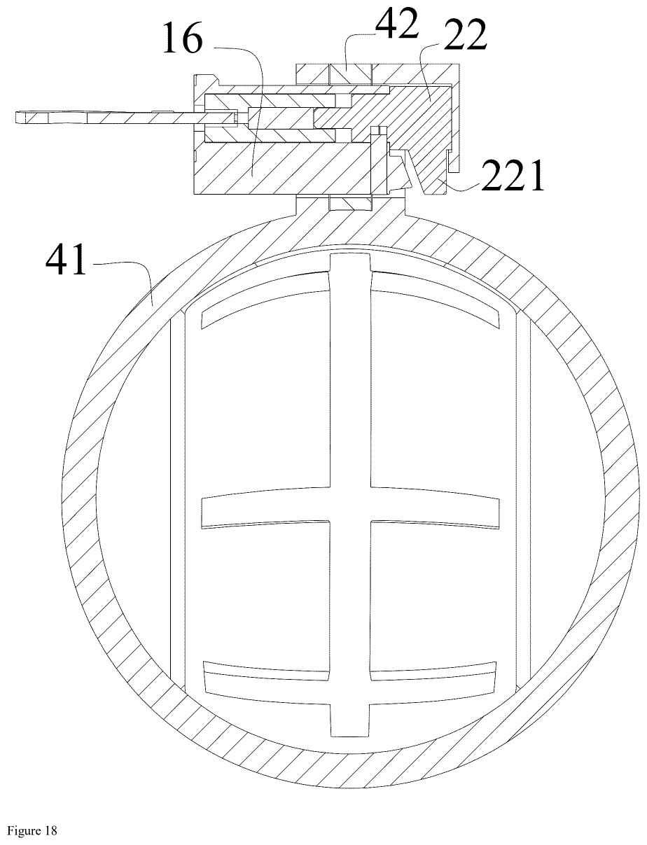

Referring to FIG. 1 to FIG. 18, a locking device, configured to be inserted between a first lock housing 41 and a second lock housing 42 to restrict relative movement between first lock housing 41 and the second lock housing 42, includes:
a lock body 1, wherein the lock body 1 is provided with a limiting hole 11, a locking block 12, and a first locking protrusion 16, the locking block 12 is disposed within the limiting hole 11, and the first locking protrusion 16 is configured to restrict relative rotation between the first lock housing 41 and the second lock housing 42;
a locking assembly 2, wherein the locking assembly 2 is provided with a locking groove 211 and a second locking protrusion 221, a portion of the locking assembly 2 is disposed within the limiting hole 11, and the locking assembly 2 is configured to move between a locked position and an unlocked position;
when the locking assembly 2 is in the locked position, the locking block 12 is inserted into the locking groove 211, and the second locking protrusion 221 is engaged with the first lock housing 41 to prevent extraction of the locking device from the first lock housing 41 and the second lock housing 42;
when the locking assembly 2 is in the unlocked position, the locking groove 211 is disengaged from the locking block 12, the second locking protrusion 221 is detached from the first lock housing 41, and the second locking protrusion 221 is disposed in an initial position to enable the extraction of the locking device from the first lock housing 41 and the second lock housing 42.

By the arrangement of the above structure, the locking device featuring a simple structure and convenient operation is provided. To restrict relative movement between the first lock housing 41 and the second lock housing 42, the locking device is inserted between them, and the locking assembly 2 is moved to the locked position. Here, the locking block 12 on the lock body 1 precisely engages the locking groove 211 of the locking assembly 2, while the second locking protrusion 221 is engaged with the first lock housing 41, preventing removal of the locking device and thereby restricting relative movement. Additionally, the first locking protrusion 16 restricts relative rotation between the first lock housing 41 and the second lock housing 42, establishing a secure locked state that prevents accidental opening and ensures item safety. For unlocking, moving the locking assembly 2 to the unlocked position disengages the locking groove 211 from the locking block 12, releasing constraints between the assembly 2 and lock body 1. Simultaneously, the second locking protrusion 221 disengages from the first lock housing 41 and is arranged in correspondence with the first locking protrusion 16, allowing the locking device to be removed for rapid unlocking. This design not only simplifies the operation process but also enhances structural stability, further improving the user experience. For example, when used to lock toys, the device maintains a secure locked state while enabling easy unlocking with minimal user effort, effectively balancing security and convenience. This provides an effective solution for usage scenarios with such requirements.

Optionally, the locking groove 211 is a non-circular groove.

It should be understood that the second locking protrusion 221 is arranged corresponding to the first locking protrusion 16, meaning that when the locking assembly 2 moves between the locked position and the unlocked position, the second locking protrusion 221 does not restrict such movement. For example, the first lock housing 41 and the second lock housing 42 are provided with a sliding groove, which extends through both the first lock housing 41 and the second lock housing 42. When the second locking protrusion 221 is positioned within the sliding groove, it resides in an initial position, where it is substantially coplanar with the first locking protrusion 16. In this state, the second locking protrusion 221 does not restrict the relative movement between the first lock housing 41 and the second lock housing 42. However, when the second locking protrusion 221 engages with the first lock housing 41, it is not coplanar with the first locking protrusion 16.

In this embodiment, an edge at an end of the locking assembly 2 facing away from the second locking protrusion 221 is inwardly recessed to form the locking groove 211.

By the arrangement of the above structure, the position and shape of the locking groove 211 are effectively coordinated with both the force-bearing direction of the locking assembly 2 and the structure of the locking block 12 of the lock body 1. When the locking assembly 2 is moved to the locked position, the locking block 12 of the lock body 1 naturally falls into the recessed locking groove 211. The geometric constraint provided by the recessed edge creates a tighter fit between the locking block 12 and the locking groove 211, effectively reducing shaking of the locking assembly 2 in the locked state. Furthermore, the recessed locking groove 211 utilizes the edge space at the terminal end of the locking assembly 2 without requiring additional increases in either radial or axial dimensions of the locking device, thus enhancing its applicability in miniaturized locks.

It is to be understood that the locking groove 211 may alternatively be disposed at other positions on the locking assembly 2, such as at a middle portion of the locking assembly 2, and the locking block 12 is arranged corresponding to the locking groove 211.

In this embodiment, the locking assembly 2 includes a locking member 21 and a connecting member 22 connected to the locking member 21, and the second locking protrusion 221 is disposed at an end of the connecting member 22 facing away from the locking member 21.

By the arrangement of the above structure, the separation of the locking assembly 2 into two independent components, namely the locking member 21 and the connecting member 22, effectively reduces manufacturing and maintenance costs via modular design and simultaneously provides greater optimization potential for security, convenience, and adaptability.

In this embodiment, the locking device further includes an elastic member 3; the locking member 21 is provided with a receiving space 213, and the elastic member 3 is disposed within the receiving space 213; one end of the elastic member 3 is connected to the connecting member 22, and the other end is connected to the locking member 21; the elastic member 3 biases the locking member 21 from the unlocked position toward the locked position.

By the arrangement of the above structure, the locking device achieves automatic reset and locking functionalities. For example, when the locking device is in the unlocked state, the locking member 21 resides at the unlocked position. During the period when the locking device is in the unlocked state, the elastic member 3 deforms under force from the connecting member 22, storing elastic potential energy. Upon removal of external force, the elastic member 3 releases this energy. Since the elastic member 3 connects at one end to the connecting member 22 and at the other end to the locking member 21, the force released from the elastic potential energy of the elastic member 3 drives the locking member 21 toward the locked position, effecting automatic reset. Furthermore, the elastic member 3 continuously biases the locking member 21 toward the locked position. Under normal conditions, this tendency enables the locking member 21 to stably remain at the locked position, ensuring a secured locked state and improving lock safety and reliability.

In this embodiment, the elastic member 3 is configured to match the receiving space 213 in both size and shape.

By the arrangement of the above structure, the elastic member 3 is constrained to move linearly along the axial direction during both compression and reset operations, thereby preventing skewing or jamming due to excessive spatial clearance, or stress concentration caused by insufficient space. For example, when a cylindrical spring is matched with a cylindrical receiving space 213, radial displacement is minimized, ensuring uniform spring force application on the unlocked object. Furthermore, by dimensioning and shaping the receiving space 213 to match the elastic member 3, ingress of external contaminants (e.g., dust) into the receiving space 213 is effectively prevented, mitigating interference from environmental factors.

In this embodiment, the locking member 21 is movable along a longitudinal axis of the limiting hole 11 between the locked position and the unlocked position.

By the arrangement of the above structure, the longitudinal axis of the limiting hole 11 provides a definitive and exclusive guiding path for the horizontal movement of the locking member 21 along the longitudinal axis. Specifically, the locking member 21 is guided to move solely along this longitudinal axis direction, thereby eliminating potential misalignment, wobbling, or other instability during operation. For example, in practical applications, such as during frequent locking and unlocking cycles, this arrangement ensures the locking member 21 consistently follows the predetermined path, which significantly enhances the operational stability and reliability of the locking device.

In this embodiment, the connecting member 22 and the locking member 21 are rotatable about the longitudinal axis of the limiting hole 11 between a first position and a second position.

By the arrangement of the above structure, the arrangement further enhances the guiding and limiting functionality of the locking assembly 2 during its movement from the locked position to the unlocked position, improving the safety, stability, and operational precision of the locking device so that during rotational movement of the locking assembly 2 about the longitudinal axis, the limiting groove 223 provides both structural support and rotational guidance, constraining the locking assembly 2 to pivot strictly within the angular path defined by the limiting groove 223. This constrained motion prevents wobbling, misalignment, or jamming during operation, ensuring a smooth unlocking process. The stabilized movement pattern promotes even wear distribution across interacting components during extended use, reducing abnormal friction and impact damage. Consequently, the operational lifespan of the locking device is substantially prolonged.

It should be understood that when the connecting member 22 and the locking member 21 are at the first position, the second locking protrusion 221 is engaged with the first lock housing 41; when the connecting member 22 and the locking member 21 are at the second position, the second locking protrusion 221 is arranged corresponding to the first locking protrusion 16.

In this embodiment, the connecting member 22 is provided with a limiting groove 223 configured to enable rotation of the connecting member 22 between the first position and the second position; the lock body 1 is provided with a limiting member 13 inserted into the limiting groove 223 to retain at least a portion of the connecting member 22 within the limiting hole 11.

By the arrangement of the above structure, the arrangement provides precise and effective movement limitation for the locking assembly 2 between the locked and unlocked positions by restricting rotation of the connecting member 22 between the first position and the second position. Specifically, when the locking assembly 2 moves from the locked position to the unlocked position, the limiting member 13 on the lock body 1 is inserted into the limiting groove 223, and this cooperation defines both the exact movement path and permissible range for the locking assembly 2. This ensures that the locking assembly 2 moves strictly along its predetermined path, eliminating any deviation, wobbling, or jamming during operation. As a result, the locking and unlocking operations of the locking device are executed with consistent smoothness.

Optionally, the limiting groove 223 has a length corresponding to rotational displacement from the first position to the second position.

In this embodiment, the limiting groove 223 is a sector-shaped groove, and a central angle of the sector-shaped groove ranges from 30° to 90°.

By the arrangement of the above structure, the arrangement provides a relatively reasonable rotational range for user operation. An excessively small angular range would require overly precise operation, increasing the likelihood of user error; conversely, an excessively large range would complicate the operation and prolong unlocking duration. The present angular range strikes an optimal balance, allowing users to easily and accurately control the rotation of the locking assembly 2 without excessive complexity, thereby significantly enhancing user experience. Furthermore, the sector-shaped groove is geometrically conformal to the rotational trajectory of locking assembly 2 about its axis, providing smooth rotational guidance. During operation, locking assembly 2 can move smoothly along the arcuate path of the sector-shaped groove, minimizing jamming resistance and ensuring exceptionally smooth locking and unlocking operation.

Optionally, the sector-shaped groove has a central angle of 45 degrees.

In this embodiment, the lock body 1 is provided with an insertion hole 14 in communication with the limiting groove 223, and the limiting member 13 is removably arranged within the insertion hole 14; when the limiting member 13 is disposed within the insertion hole 14 and an end of the limiting member 13 is inserted into the limiting groove 223, at least a portion of the connecting member 22 is disposed within the limiting hole 11.

By the arrangement of the above structure, the arrangement ensures a stable cooperation between the limiting member 13 and the locking assembly 2. During operation of the locking assembly 2, the limiting member 13 maintains continuous contact with and guidance along the limiting groove 223, reducing risks of jamming or malfunction caused by wobbling or misalignment. This arrangement guarantees normal operation of the locking device even after prolonged use, significantly improving reliability and durability. Furthermore, in the event of damage to the limiting member 13, it can be conveniently replaced by removal from the insertion hole 14, thereby reducing usage costs and simplifying repair procedures.

In this embodiment, an end of the connecting member 22 facing away from the second locking protrusion 221 defines a connecting end 222; the locking member 21 is provided with a recessed structure, the recessed structure is configured to match the connecting end 222 in both shape and size, and the connecting end 222 is inserted into the recessed structure.

By configuring the shape and size of the recessed structure to precisely correspond to the connecting end 222, the connecting end 222 is tightly insertable into the recessed structure, thereby achieving a seamless interface between the two. This precise fitting relationship minimizes clearance at the connection, preventing wobbling or loosening of the connecting member 22 during operation. Consequently, the locking device maintains stability and reliability throughout locking and unlocking processes. Additionally, the recessed structure restricts radial movement of the connecting end 222 while providing stable axial support.

In this embodiment, the recessed structure has a non-circular configuration.

By the arrangement of the above structure, when the locking member 21 rotates, the non-circular configuration of the locking member 21 utilizes its characteristic to causes the connecting member 22 to rotate synchronously, thereby simplifying the structure of this invention's locking device and improving user convenience.

In this embodiment, both the lock body 1 and the locking assembly 2 are made of non-metallic materials.

By the arrangement of the above structure, the weight of the locking device is significantly reduced, thereby decreasing inertial forces during movement or rotation. This reduction enables lighter and smoother user operations including key turning of the locking device, pushing, and pulling.

In this embodiment, the lock body 1 is provided with a first lock hole 15, and the locking member 21 is provided with a second lock hole 212. The first lock hole 15 and the second lock hole 212 are arranged correspondingly. The second lock hole 212 corresponds to an unlocking object in size and shape, while the inner wall of the first lock hole 15 does not contact the unlocking object.

By the arrangement of the above structure, the unlocking object need only engage with the second lock hole 212 to actuate the locking member 21, while the first lock hole 15 as a fixed positioning structure is not directly subject to the insertion or rotational forces of the unlocking object. This arrangement maintains precise relative positioning between the locking member 21 and the lock body 1; and prevents direct wear to the lock body 1 during unlocking operations, thereby enhancing both structural stability and service life of the locking device. Furthermore, the targeted design of size and shape of the second lock hole 212 enables exclusive compatibility with a specific unlocking object, establishing unique unlocking logic that significantly improves the anti-tampering performance and security rating of the device.

A lock includes a locking device, a first lock housing 41, and a second lock housing 42.

The locking device includes:
a lock body 1, wherein the lock body 1 is provided with a limiting hole 11, a locking block 12, and a first locking protrusion 16, the locking block 12 is disposed within the limiting hole 11, and the first locking protrusion 16 is configured to restrict relative rotation between the first lock housing 41 and the second lock housing 42;
a locking assembly 2, wherein the locking assembly 2 is provided with a locking groove 211 and a second locking protrusion 221, a portion of the locking assembly 2 is disposed within the limiting hole 11, and the locking assembly 2 is configured to move between a locked position and an unlocked position;
when the locking assembly 2 is in the locked position, the locking block 12 is inserted into the locking groove 211, and the second locking protrusion 221 is engaged with the first lock housing 41 to prevent extraction of the locking device from the first lock housing 41 and the second lock housing 42;
when the locking assembly 2 is in the unlocked position, the locking groove 211 is disengaged from the locking block 12, the second locking protrusion 221 is detached from the first lock housing 41, and the second locking protrusion 221 is configured to correspond to the first locking protrusion 16 to enable the extraction of the locking device from the first lock housing 41 and the second lock housing 42.

By the arrangement of the above structure, the locking device featuring a simple structure and convenient operation is provided. To restrict relative movement between the first lock housing 41 and the second lock housing 42, the locking device is inserted between them, and the locking assembly 2 is moved to the locked position. Here, the locking block 12 on the lock body 1 precisely engages the locking groove 211 of the locking assembly 2, while the second locking protrusion 221 is engaged with the first lock housing 41, preventing removal of the locking device and thereby restricting relative movement. Additionally, the first locking protrusion 16 restricts relative rotation between the first lock housing 41 and the second lock housing 42, establishing a secure locked state that prevents accidental opening and ensures item safety. For unlocking, moving the locking assembly 2 to the unlocked position disengages the locking groove 211 from the locking block 12, releasing constraints between the assembly 2 and lock body 1. Simultaneously, the second locking protrusion 221 disengages from the first lock housing 41 and is arranged in correspondence with the first locking protrusion 16, allowing the locking device to be removed for rapid unlocking. This design not only simplifies the operation process but also enhances structural stability, further improving the user experience. For example, when used to lock toys, the device maintains a secure locked state while enabling easy unlocking with minimal user effort, effectively balancing security and convenience. This provides an effective solution for usage scenarios with such requirements.

Optionally, the locking groove 211 is a non-circular groove.

It should be understood that the second locking protrusion 221 is arranged corresponding to the first locking protrusion 16, meaning that when the locking assembly 2 moves between the locked position and the unlocked position, the second locking protrusion 221 does not restrict such movement. For example, the first lock housing 41 and the second lock housing 42 are provided with a sliding groove, which extends through both the first lock housing 41 and the second lock housing 42. When the second locking protrusion 221 is positioned within the sliding groove, it resides in an initial position, where it is substantially coplanar with the first locking protrusion 16. In this state, the second locking protrusion 221 does not restrict the relative movement between the first lock housing 41 and the second lock housing 42. However, when the second locking protrusion 221 engages with the first lock housing 41, it is not coplanar with the first locking protrusion 16.

In this embodiment, the locking assembly 2 comprises a locking member 21 and a connecting member 22 connected to the locking member 21, and the second locking protrusion 221 is disposed at an end of the connecting member 22 facing away from the locking member 21; the locking device further comprises an elastic member 3; the locking member 21 is provided with a receiving space 213, and the elastic member 3 is disposed within the receiving space 213; one end of the elastic member 3 is connected to the connecting member 22, and the other end is connected to the locking member 21; the elastic member 3 biases the locking member 21 from the unlocked position toward the locked position.

By the arrangement of the above structure, the separation of the locking assembly 2 into two independent components, namely the locking member 21 and the connecting member 22, effectively reduces manufacturing and maintenance costs via modular design and simultaneously provides greater optimization potential for security, convenience, and adaptability. In addition, the locking device achieves automatic reset and locking functionalities. For example, when the locking device is in the unlocked state, the locking member 21 resides at the unlocked position. During this process, the elastic member 3 deforms under force from the connecting member 22, storing elastic potential energy. Upon removal of external force, the elastic member 3 releases this energy. Since the elastic member 3 connects at one end to the connecting member 22 and at the other end to the locking member 21, the released force drives the locking member 21 toward the locked position, effecting automatic reset. Furthermore, the elastic member 3 continuously biases the locking member 21 toward the locked position. Under normal conditions, this tendency enables the locking member 21 to stably remain at the locked position, ensuring a secured locked state and improving lock safety and reliability.

In this embodiment, the locking member 21 is movable along a longitudinal axis of the limiting hole 11 between the locked position and the unlocked position; the connecting member 22 and the locking member 21 are rotatable about a longitudinal axis of the limiting hole 11 between a first position and a second position.

By the arrangement of the above structure, the longitudinal axis of the limiting hole 11 provides a definitive and exclusive guiding path for the horizontal movement of the locking member 21. Specifically, the locking member 21 is guided to move solely along this longitudinal axis direction, thereby eliminating potential misalignment, wobbling, or other instability during operation. For example, in practical applications, such as during frequent locking and unlocking cycles, this arrangement ensures the locking member 21 consistently follows the predetermined path, which significantly enhances the operational stability and reliability of the locking device. In addition, the arrangement further enhances the guiding and limiting functionality of the locking assembly 2 during its movement from the locked position to the unlocked position, improving the safety, stability, and operational precision of the locking device so that during rotational movement of the locking assembly 2 about the longitudinal axis, the limiting groove 223 provides both structural support and rotational guidance, constraining the locking assembly 2 to pivot strictly within the angular path defined by the limiting groove 223. This constrained motion prevents wobbling, misalignment, or jamming during operation, ensuring a smooth unlocking process. The stabilized movement pattern promotes even wear distribution across interacting components during extended use, reducing abnormal friction and impact damage. Consequently, the operational lifespan of the locking device is substantially prolonged.

It should be understood that when the connecting member 22 and the locking member 21 are at the first position, the second locking protrusion 221 is engaged with the first lock housing 41; when the connecting member 22 and the locking member 21 are at the second position, the second locking protrusion 221 is arranged corresponding to the first locking protrusion 16.

In this embodiment, the connecting member 22 is provided with a limiting groove 223 configured to enable rotation of the connecting member 22 between the first position and the second position; the lock body 1 is provided with a limiting member 13 inserted into the limiting groove 223, and at least a portion of the connecting member 22 is disposed within the limiting hole 11.

By the arrangement of the above structure, the arrangement provides precise and effective movement limitation for the locking assembly 2 between the locked and unlocked positions by restricting rotation of the connecting member 22 between the first position and the second position. Specifically, when the locking assembly 2 moves from the locked position to the unlocked position, the limiting member 13 on the lock body 1 is inserted into the limiting groove 223, and this cooperation defines both the exact movement path and permissible range for the locking assembly 2. This ensures that the locking assembly 2 moves strictly along its predetermined path, eliminating any deviation, wobbling, or jamming during operation. As a result, the locking and unlocking operations of the locking device are executed with consistent smoothness.

In this embodiment, the limiting groove 233 is a sector-shaped groove, and a central angle of the sector-shaped groove ranges from 30° to 90°.

By the arrangement of the above structure, the arrangement provides a relatively reasonable rotational range for user operation. An excessively small angular range would require overly precise operation, increasing the likelihood of user error; conversely, an excessively large range would complicate the operation and prolong unlocking duration. The present angular range strikes an optimal balance, allowing users to easily and accurately control the rotation of the locking assembly 2 without excessive complexity, thereby significantly enhancing user experience. Furthermore, the sector-shaped groove is geometrically conformal to the rotational trajectory of locking assembly 2 about its axis, providing smooth rotational guidance. During operation, locking assembly 2 can move smoothly along the arcuate path of the sector-shaped groove, minimizing jamming resistance and ensuring exceptionally smooth locking and unlocking operation.

Optionally, the sector-shaped groove has a central angle of 45 degrees.

In this embodiment, an end of the connecting member 22 facing away from the second locking protrusion 221 defines a connecting end 222; the locking member 21 is provided with a recessed structure, the recessed structure is configured to match the connecting end 222 in both shape and size, and the connecting end 222 is inserted into the recessed structure.

By configuring the shape and size of the recessed structure to precisely correspond to the connecting end 222, the connecting end 222 is tightly insertable into the recessed structure, thereby achieving a seamless interface between the two. This precise fitting relationship minimizes clearance at the connection, preventing wobbling or loosening of the connecting member 22 during operation. Consequently, the locking device maintains stability and reliability throughout locking and unlocking processes. Additionally, the recessed structure restricts radial movement of the connecting end 222 while providing stable axial support.

In this embodiment, the recessed structure has a non-circular configuration.

By the arrangement of the above structure, when the locking member 21 rotates, the non-circular configuration of the locking member 21 utilizes its characteristic to cause the connecting member 22 to rotate synchronously, thereby simplifying the structure of this invention's locking device and improving user convenience.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

1. A locking device, configured to be inserted between a first lock housing and a second lock housing to restrict relative movement therebetween, comprising:
a lock body, wherein the lock body is provided with a limiting hole, a locking block, and a first locking protrusion, the locking block is disposed within the limiting hole, and the first locking protrusion is configured to restrict relative rotation between the first lock housing and the second lock housing;
a locking assembly, wherein the locking assembly is provided with a locking groove and a second locking protrusion, a portion of the locking assembly is disposed within the limiting hole, and the locking assembly is configured to move between a locked position and an unlocked position;
when the locking assembly is in the locked position, the locking block is inserted into the locking groove, and the second locking protrusion is engaged with the first lock housing to prevent extraction of the locking device from the first lock housing and the second lock housing.

2. The locking device according to claim 1, wherein an edge at an end of the locking assembly facing away from the second locking protrusion is inwardly recessed to form the locking groove.

3. The locking device according to claim 1, wherein the locking assembly comprises a locking member and a connecting member connected to the locking member, and the second locking protrusion is disposed at an end of the connecting member facing away from the locking member.

4. The locking device according to claim 3, wherein the locking device further comprises an elastic member; the locking member is provided with a receiving space, and the elastic member is disposed within the receiving space; one end of the elastic member is connected to the connecting member, and the other end is connected to the locking member; the elastic member biases the locking member from the unlocked position toward the locked position.

5. The locking device according to claim 4, wherein the elastic member is configured to match the receiving space in both size and shape.

6. The locking device according to claim 3, wherein the locking member is movable along a longitudinal axis of the limiting hole between the locked position and the unlocked position.

7. The locking device according to claim 3, wherein the connecting member and the locking member are rotatable about the longitudinal axis of the limiting hole between a first position and a second position.

8. The locking device according to claim 7, wherein the connecting member is provided with a limiting groove configured to enable rotation of the connecting member between the first position and the second position; the lock body is provided with a limiting member inserted into the limiting groove to retain at least a portion of the connecting member within the limiting hole.

9. The locking device according to claim 8, wherein the limiting groove is a sector-shaped groove, and a central angle of the sector-shaped groove ranges from 30° to 90°.

10. The locking device according to claim 8, wherein the lock body is provided with an insertion hole in communication with the limiting groove, and the limiting member is removably arranged within the insertion hole; when the limiting member is disposed within the insertion hole and an end of the limiting member is inserted into the limiting groove, at least a portion of the connecting member is disposed within the limiting hole.

11. The locking device according to claim 3, wherein an end of the connecting member facing away from the second locking protrusion defines a connecting end; the locking member is provided with a recessed structure, the recessed structure is configured to match the connecting end in both shape and size, and the connecting end is inserted into the recessed structure.

12. The locking device according to claim 11, wherein the recessed structure has a non-circular configuration.

13. The locking device according to claim 1, wherein both the lock body and the locking assembly are made of non-metallic materials.

14. A lock comprising:
a locking device, a first lock housing, and a second lock housing;
the locking device comprising:
a lock body, wherein the lock body is provided with a limiting hole, a locking block, and a first locking protrusion, the locking block is disposed within the limiting hole, and the first locking protrusion is configured to restrict relative rotation between the first lock housing and the second lock housing;
a locking assembly, wherein the locking assembly is provided with a locking groove and a second locking protrusion, a portion of the locking assembly is disposed within the limiting hole, and the locking assembly is configured to move between a locked position and an unlocked position;
when the locking assembly is in the locked position, the locking block is inserted into the locking groove, and the second locking protrusion is engaged with the first lock housing to prevent extraction of the locking device from the first lock housing and the second lock housing;
when the locking assembly is in the unlocked position, the locking groove is disengaged from the locking block, the second locking protrusion is detached from the first lock housing, and the second locking protrusion is configured to correspond to the first locking protrusion to enable the extraction of the locking device from the first lock housing and the second lock housing.

15. The lock according to claim 14, wherein the locking assembly comprises a locking member and a connecting member connected to the locking member, and the second locking protrusion is disposed at an end of the connecting member facing away from the locking member; the locking device further comprises an elastic member; the locking member is provided with a receiving space, and the elastic member is disposed within the receiving space; one end of the elastic member is connected to the connecting member, and the other end is connected to the locking member; the elastic member biases the locking member from the unlocked position toward the locked position.

16. The lock according to claim 15, wherein the locking member is movable along a longitudinal axis of the limiting hole between the locked position and the unlocked position; the connecting member and the locking member are rotatable about a longitudinal axis of the limiting hole between a first position and a second position.

17. The lock according to claim 16, wherein the connecting member is provided with a limiting groove configured to enable rotation of the connecting member between the first position and the second position; the lock body is provided with a limiting member inserted into the limiting groove, and at least a portion of the connecting member is disposed within the limiting hole.

18. The lock according to claim 17, wherein the limiting groove is a sector-shaped groove, and a central angle of the sector-shaped groove ranges from 30° to 90°.

19. The lock according to claim 15, wherein an end of the connecting member facing away from the second locking protrusion defines a connecting end; the locking member is provided with a recessed structure, the recessed structure is configured to match the connecting end in both shape and size, and the connecting end is inserted into the recessed structure.

20. The lock according to claim 19, wherein the recessed structure has a non-circular configuration.
